(19) United States
(12) Patent Application Publication
(10) Pub. No.: US 2013/0194136 A1
(43) Pub. Date: Aug. 1, 2013

(54) MOBILE WIRELESS COMMUNICATIONS DEVICE WITH MULTIPLE-BAND ANTENNA AND RELATED METHODS

(71) Applicants: Andreas HANDRO, Munster (DE); Christopher Wehrmann, Bochum (DE); Michael Kühn, Bochum (DE)

(72) Inventors: Andreas HANDRO, Munster (DE); Christopher Wehrmann, Bochum (DE); Michael Kühn, Bochum (DE)

(73) Assignee: Research In Motion Limited, Waterloo (CA)

(21) Appl. No.: 13/359,918

(22) Filed: Jan. 27, 2012

(51) Int. Cl. H01Q 1/24; H01P 11/00; H01Q 5/00

(52) U.S. Cl. 343/702; 343/700 MS; 29/601

(57) ABSTRACT

A mobile wireless communications device may include a housing, a wireless transceiver carried by the housing, and a multiple-band antenna carried by the housing and coupled to the wireless transceiver. The multiple-band antenna may include a first radiator comprising a radiator element and a parasitic element adjacent to the radiator element. The parasitic element may be selectively switchable between floating and grounded states. The multiple-band antenna may include a second radiator insulated from the first radiator.

### TECHNICAL FIELD

The present invention relates to the field of communications, and, more particularly, to wireless communications and related methods.

### BACKGROUND

Cellular communication systems continue to grow in popularity and have become an integral part of both personal and business communications. Cellular telephones allow users to place and receive phone calls almost anywhere they travel. Moreover, as cellular telephone technology is improved, so too has the functionality of cellular devices. For example, many cellular devices now incorporate Personal Digital Assistant (PDA) features such as calendars, address books, task lists, calculators, memo and writing programs, etc. These multi-function devices usually allow users to wirelessly send and receive electronic mail (email) messages and access the Internet via a cellular network and/or a wireless local area network (WLAN), for example.

As the functionality of cellular devices continues to increase, so too does demand for smaller devices that are easier and more convenient for users to carry. Nevertheless, the move towards multi-functional devices makes miniaturization more difficult as the requisite number of installed components increases. Indeed, the typical cellular device may include several antennas, for example, a cellular antenna, a global positioning system antenna, and a WiFi IEEE 802.11g antenna. These antennas may comprise external antennas and internal antennas.

Generally speaking, internal antennas allow cellular devices to have a smaller footprint. Moreover, they are also preferred over external antennas for mechanical and ergonomic reasons. Internal antennas are also protected by the cellular device's housing and therefore tend to be more durable than external antennas. External antennas may be cumbersome and may make the cellular device difficult to use, particularly in limited-space environments. Yet, one potential drawback of typical internal antennas is that they are in relatively close proximity to the user's head when the cellular device is in use, thereby increasing the specific absorption rate (SAR). Yet more, hearing aid compatibility (HAC) may also be affected negatively. Also, other components within the cellular device may cause interference with or may be interfered by the internal antenna.

### BRIEF DESCRIPTION OF THE DRAWINGS

FIG. 1 is a schematic diagram of an example embodiment of the mobile wireless communications device.

FIG. 2 is a top plan view of an example embodiment of a multiple-band antenna from the mobile wireless communications device of FIG. 1.

FIG. 3 is a perspective view of an example embodiment of the mobile wireless communications device of FIG. 1 with the housing removed.

FIG. 4 is a top plan view of an example embodiment of a circuit board from the mobile wireless communications device of FIG. 1.

FIG. 5 is a schematic block diagram of an example embodiment of transmit and receive pathways for the mobile wireless communications device of FIG. 1.

FIG. 6 is a schematic block diagram of an example embodiment of the feed path for the second radiator of the mobile wireless communications device of FIG. 1.

FIG. 7 is a schematic circuit diagram of an example embodiment of the feed path for the second radiator of the mobile wireless communications device of FIG. 1.

FIG. 8 is a schematic block diagram of an example embodiment of the feed and parasitic paths for the first radiator of the mobile wireless communications device of FIG. 1.

FIG. 9 is a schematic circuit diagram of an example embodiment of the feed and parasitic paths for the first radiator of the mobile wireless communications device of FIG. 1.

FIG. 10 is a schematic circuit diagram of an example embodiment of the feed path for the first radiator of the mobile wireless communications device of FIG. 1.

FIG. 11 is a schematic circuit diagram of an example embodiment of the parasitic path for the first radiator of the mobile wireless communications device of FIG. 1.

FIGS. 12-26 are diagrams illustrating performance of an example embodiment of a multiple-band antenna from the mobile wireless communications device of FIG. 1

FIG. 27 is a schematic block diagram illustrating example components of a mobile wireless communications device that may be used with the mobile wireless communications device of FIG. 1.

### DETAILED DESCRIPTION OF THE PREFERRED EMBODIMENTS

The present description is made with reference to the accompanying drawings, in which embodiments are shown. However, many different embodiments may be used, and thus the description should not be construed as limited to the embodiments set forth herein. Rather, these embodiments are provided so that this disclosure will be thorough and complete. Like numbers refer to like elements throughout.

Generally speaking, a mobile wireless communications device may include a housing, at least one wireless transceiver carried by the housing, and a multiple-band antenna carried by the housing and coupled to the at least one wireless transceiver. Example mobile wireless communications devices may include portable or personal media players (e.g., music or MP3 players, video players, etc.), remote controls (e.g., television or stereo remotes, etc.), portable gaming devices, portable or mobile telephones, smartphones, tablet computers, etc. The multiple-band antenna may include a first radiator comprising a radiator element and a parasitic element adjacent thereto, the parasitic element being selectively switchable between floating and grounded states, and a second radiator insulated from the first radiator.

More specifically, the multiple-band antenna may comprise a dielectric substrate supporting the first and second radiators. The dielectric substrate may have a non-planar shape, for example. The dielectric substrate may be carried by a bottom of the housing, and the first and second radiators may be carried by respective opposing first and second sides of the dielectric substrate.

Additionally, the second radiator may comprise first and second branches coupled together with a T-shaped slot therebetween. The second radiator may comprise a feed connection on the first branch, and a reference voltage connection on the second branch. For example, the T-shaped slot may open outwardly and between the first and second branches.

Moreover, the radiator element may comprise a first branch extending alongside the parasitic element, and a second branch extending outwardly from the first branch. The second branch may have a bend in a medial portion thereof. The radiator element may comprise a feed connection on the first branch. For example, the parasitic element may have a rectangular shape.

Another aspect is directed to a method of making a mobile wireless communications device. The method may comprise forming a multiple-band antenna to comprise a first radiator comprising a radiator element and a parasitic element adjacent thereto, the parasitic element being selectively switchable between floating and grounded states, and a second radiator insulated from the first radiator. The method may also include coupling at least one wireless transceiver to be carried by a housing, and coupling the multiple-band antenna to be carried by the housing and to the at least one wireless transceiver.

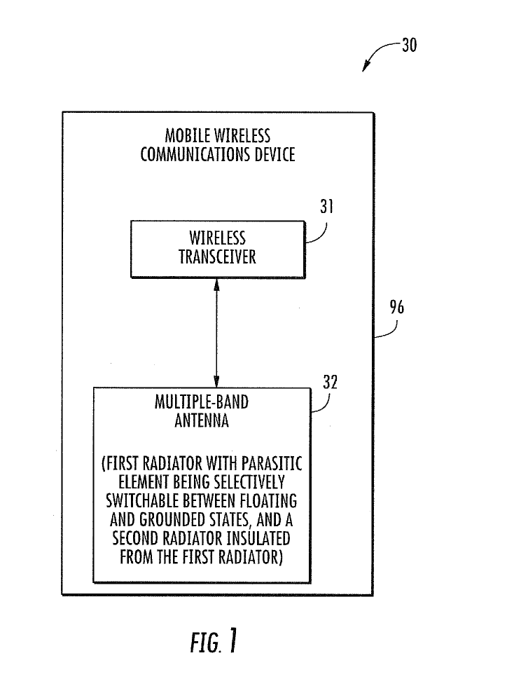

Referring initially to FIGS. 1-3, a mobile wireless communications device 30 illustratively includes a housing 96, a wireless transceiver 31 carried by the housing, and a multiple-band antenna 32 carried by the housing and coupled to the wireless transceiver. The multiple-band antenna 32 illustratively includes a first radiator 33 comprising a radiator element 36, and a parasitic element 35 adjacent thereto. For example, the first radiator 33 may comprise a low band radiator operating at a frequency band of 824-960 MHz.

In particular, the parasitic element 35 is aligned substantially parallel to the radiator element 36. The parasitic element 35 may be selectively switchable between floating and grounded states, i.e. it is coupled to a plurality of differing impedances. The parasitic element 35 is switched to change the capacitive load of the radiator element 36 and to control the resonance frequency of the same, thereby improving antenna performance. For example, the parasitic element 35 illustratively has a rectangle shape, but may comprise different shapes in other embodiments, such a triangle shape, a trapezoid shape, a curved shape, etc.

Moreover, the radiator element 36 illustratively includes a first branch 43 extending alongside the parasitic element 35, and a second branch 44 extending outwardly from the first branch. The radiator element 36 illustratively includes a feed connection 47 on the first branch 43. The portion of the first branch 43 proximal to the feed connection 47 illustratively has a rectangle shape, but may comprise different shapes in other embodiments, such a triangle shape, a trapezoid shape, a curved shape, etc. The radiator element 36 illustratively includes a medial portion coupling the first branch 43 and the second branch 44. The medial portion illustratively includes L-shaped slot 39 on an inner side thereof, and a protruding portion 49 on an outer side thereof. The L-shaped slot 39 may comprise different shapes in other embodiments, such a triangle shape, a trapezoid shape, a curved shape, etc. The protruding portion 49 is substantially rectangle shaped and forms a portion of a speaker receiving recess, but may comprise different shapes in other embodiments, such a triangle shape, a trapezoid shape, a curved shape, etc. The second branch 44 illustratively includes a bend 45 in a medial portion thereof. The distal end of the second branch 44 is substantially rectangle shaped, but may comprise different shapes in other embodiments, such a triangle shape, a trapezoid shape, a curved shape, etc.

The multiple-band antenna 32 illustratively includes a second radiator 34 insulated from the first radiator 33. More specifically, the multiple-band antenna 32 illustratively includes a dielectric substrate 37 supporting the first and second radiators 33-34. For example, the second radiator 34 may comprise a high band radiator operating at a frequency band of 1710-2170 MHz.

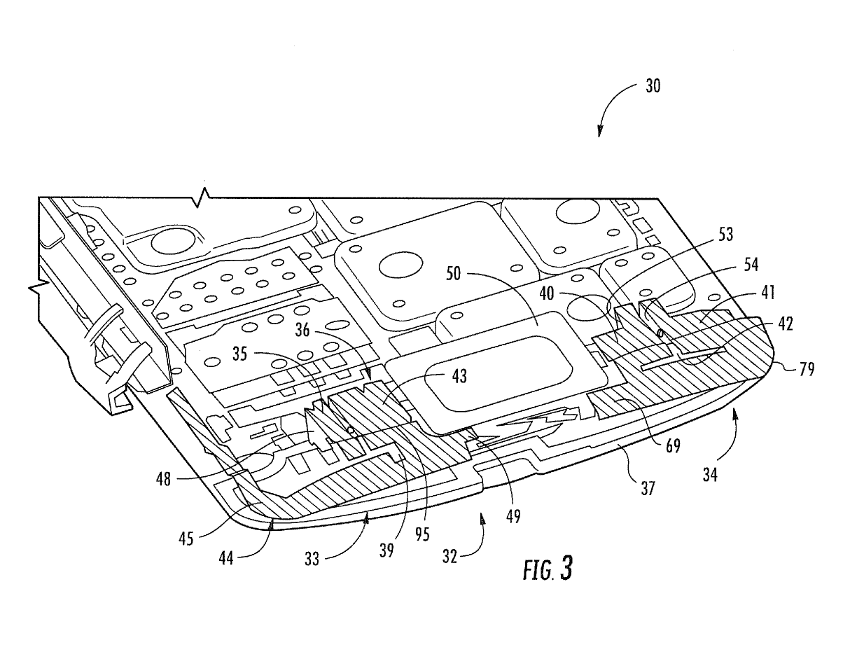

As perhaps best seen in FIG. 3, the dielectric substrate 37 illustratively includes a non-planar shape, which provides firm direct support to the multiple-band antenna 32. Indeed, the substrate 37 illustratively includes a ridge 95 extending across the bottom of the mobile wireless communications device 30, the ridge indenting the first and second radiators 33-34. The dielectric substrate 37 is illustratively carried by a bottom of the housing 96, and the first and second radiators 33-34 are carried by respective opposing first and second sides of the dielectric substrate.

Additionally, the second radiator 34 illustratively includes first and second branches 40-41 coupled together with a medial portion therebetween. The medial portion illustratively includes a T-shaped slot 42 on an inner side thereon. The T-shaped slot 42 may comprise different shapes in other embodiments, such a triangle shape, a trapezoid shape, a curved shape, etc. The medial portion illustratively includes, on an outer side thereof, a curved portion 79 and a protruding portion 69. The protruding portion 69 is illustratively substantially rectangle shaped, but may comprise different shapes in other embodiments, such a triangle shape, a trapezoid shape, a curved shape, etc. The second radiator 34 illustratively includes a feed connection 53 on the first branch 40, and a reference voltage connection 54, for example, a ground connection, on the second branch 41. The T-shaped slot 42 may open outwardly and between the first and second branches 40-41.

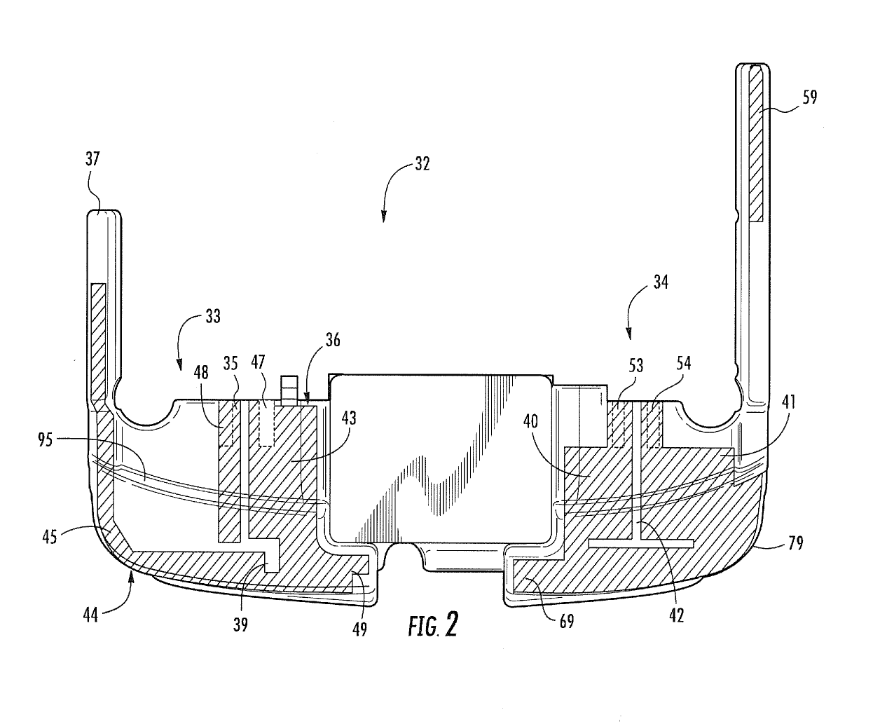

The multiple-band antenna 32 illustratively includes a tuning member 59 (FIG. 2) positioned above the second radiator 34. The tuning member 59 is illustratively rectangle shaped, but may comprise different shapes in other embodiments, such a triangle shape, a trapezoid shape, a curved shape, etc. The mobile wireless communications device 30 illustratively includes a speaker 50 (FIG. 3), and a speaker receiving recess partially defined by the protruding portions 49, 69 of the first and second radiators 33-34.

In the typical cellular device, low band resonance may cause performance issues for the high band antenna. Advantageously, the second radiator 34 is electrically insulated from the first radiator 33 and the parasitic element 35 is appropriately switched to enhance the isolation therebetween. For example, if the second radiator 34 (high band) is in use, the first radiator 33 is terminated with an isolation optimizing impedance, both the parasitic element 35 and the radiator element 36. Also, the two radiator approach with an active low band antenna and a passive high band antenna may give enough design freedom to achieve design goals (low and high band can be tuned independently, and coupling between low and high band can be controlled).

Referring now additionally to FIG. 4, the mobile wireless communications device 30 illustratively includes a circuit board 51 carrying the multiple-band antenna 32, and a speaker metal support can 91 for supporting the speaker 50. The mobile wireless communications device 30 illustratively includes a plurality of electrical contacts 52a-52c, 92a-92b carried by the circuit board 51 and for being coupled to the first and second radiators 33-34. In particular, electrical contact 52b is coupled to the parasitic element 35, electrical contact 52c is connected to the radiator element 36, electrical contact 92a is connected to the feed connection 53, and electrical contact 92b is connected to the reference voltage connection 54.

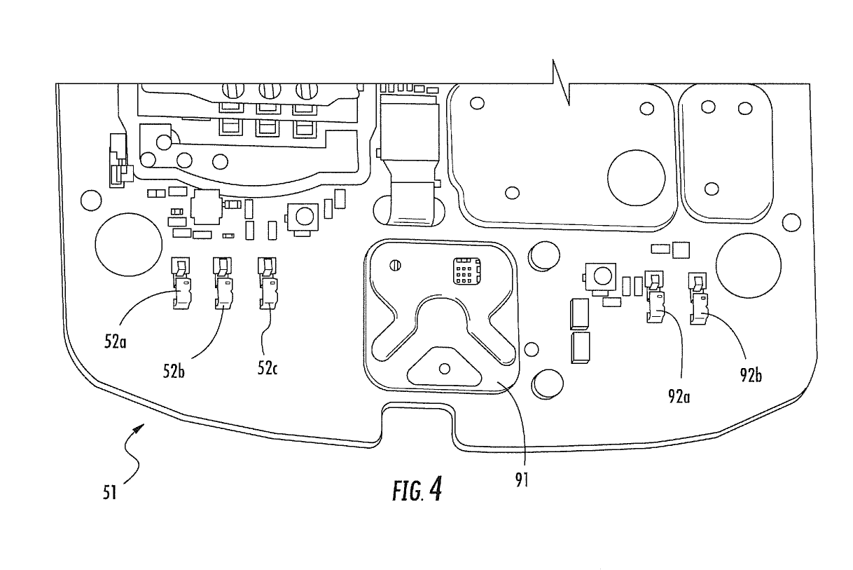

Referring now additionally to FIG. 5, the mobile wireless communications device 30 illustratively includes a transmit-receive path 60. The transmit-receive path 60 illustratively includes a processor 65, a power amplifier 64 coupled downstream therefrom, an antenna switch block 62 coupled downstream from the power amplifier, and an antenna tuner block 61 coupled between the first radiator 33 and the processor. The transmit-receive path 60 illustratively includes a diplexer block 63 coupled to the power amplifier 64, the processor 65, and the antenna switch block 62. The transmit-receive path 60 illustratively includes a pair of GSM receiver blocks (900 MHz, and 1900 MHz) 66-67 coupled between the antenna switch block 62 and the processor 65.

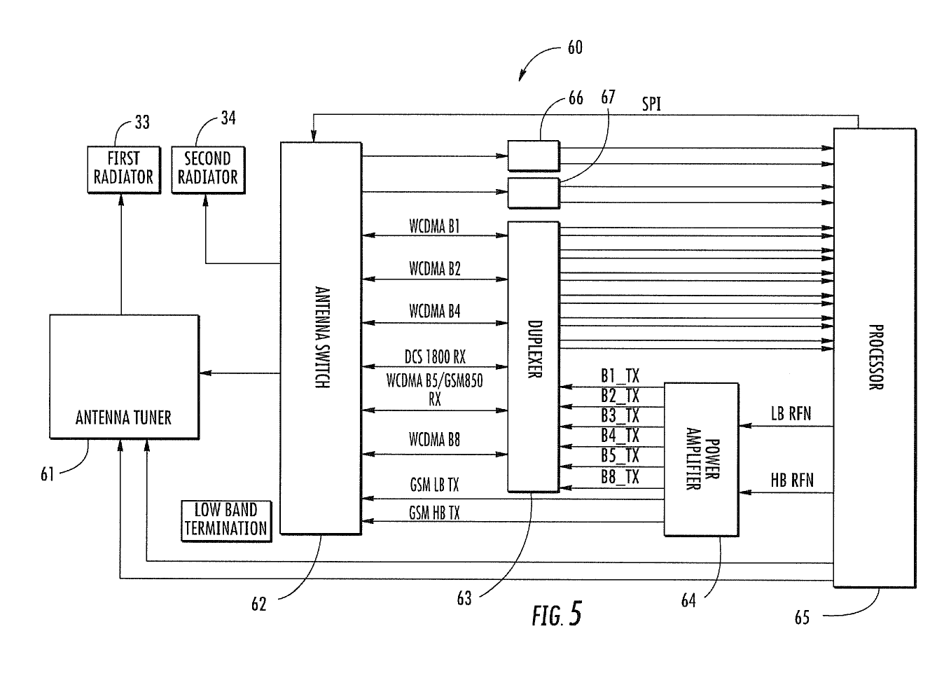

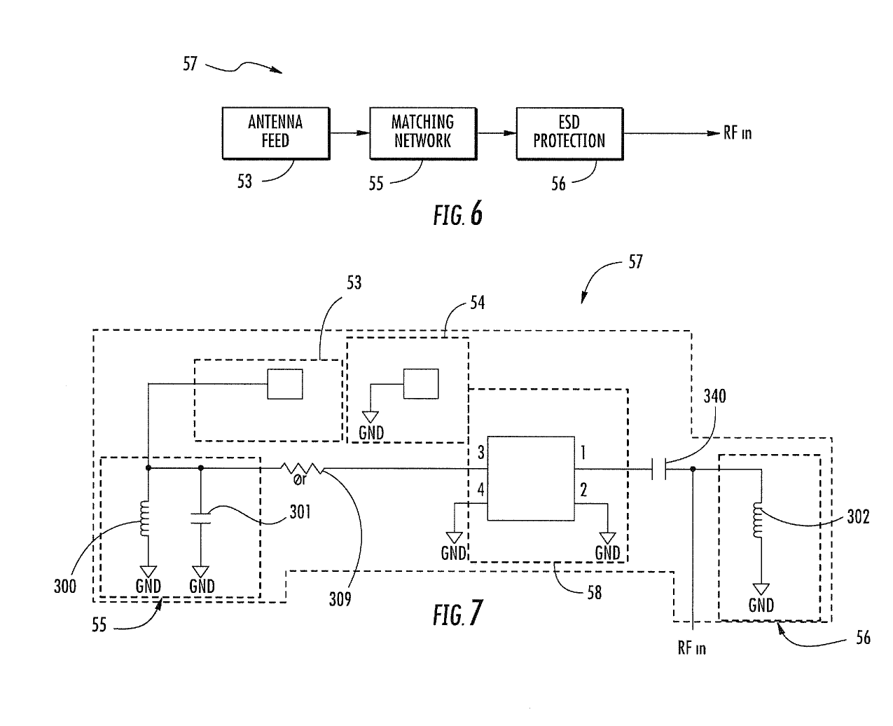

Referring now additionally to FIGS. 6-7, the mobile wireless communications device 30 illustratively includes a second radiator feed path 57 including an antenna feed connection 53, a matching network (impedance) block 55 coupled downstream therefrom, and an electrostatic discharge (ESD) protection block 56 coupled downstream therefrom and configured to provide an RF input. The second radiator feed path 57 illustratively includes a switch connector block 58 coupled between the ESD protection block 56 (inductor 302) and the matching network block 55. The switch connector block 58 is for use during production testing methods.

The matching network (impedance) block 55 illustratively includes an inductor 300, and a capacitor 301 coupled in parallel. The second radiator feed path 57 illustratively includes a resistor 309 coupling the matching network block 55 and the switch connector block 58, and a capacitor 340 coupling the switch connector block 58 to the ESD protection block 56.

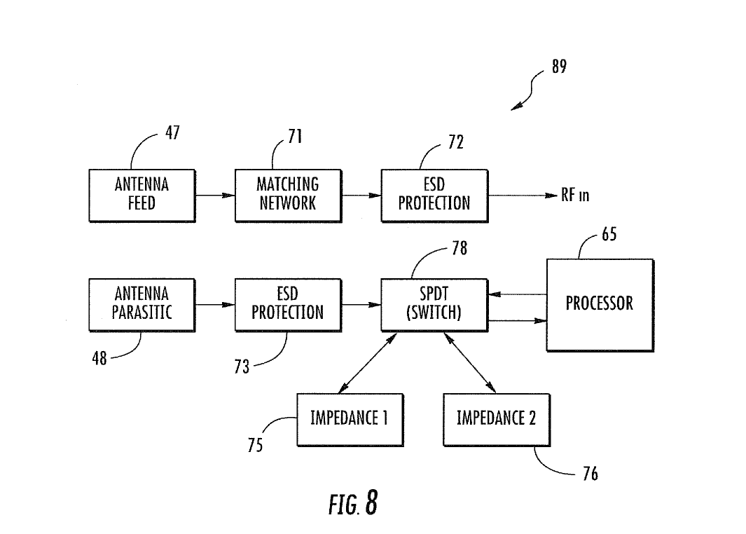

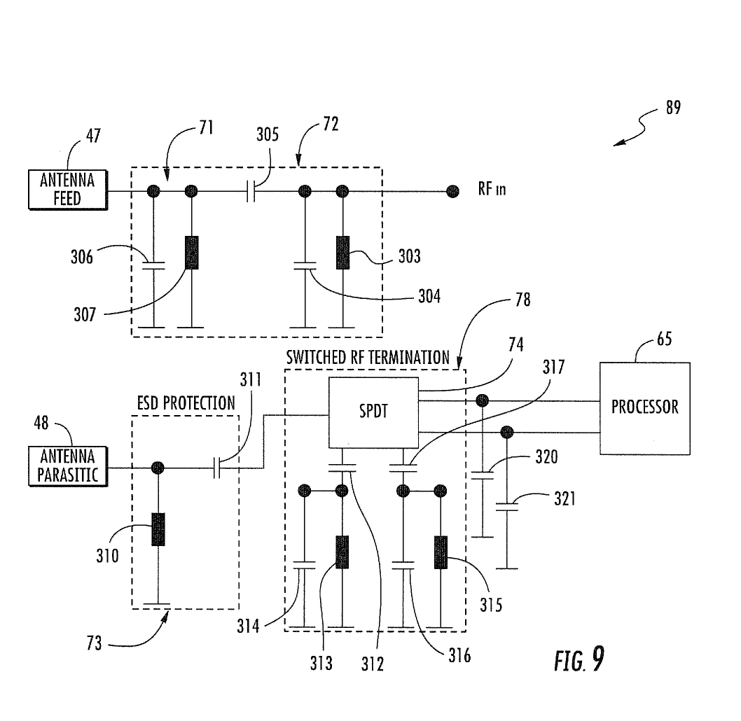

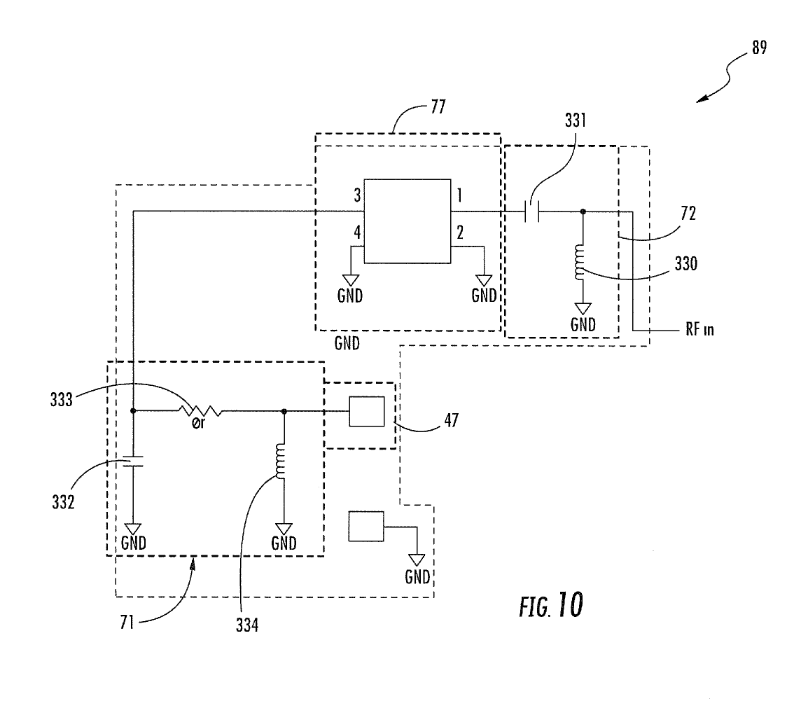

Referring now to FIGS. 8-11, the mobile wireless communications device 30 illustratively includes a first radiator feed path 89 including an antenna feed connection 47, a matching network (impedance) block 71 (capacitors 306, 332, resistors 307, 333, and inductor 334) coupled downstream therefrom, and an ESD protection block 72 (capacitors 304-305, 331, resistor 303, and inductor 330) coupled downstream therefrom and providing an RF input. The first radiator feed path 89 illustratively includes a parasitic path comprising a parasitic feed 48, an ESD protection block 73 (capacitors 311, 345, resistor 310, and inductor 344) coupled downstream therefrom, a switch block 78 coupled thereto and configured to selective coupled the parasitic element connection 48 to a pair of impedances 75-76 (capacitors 347, 343, resistor 342, and capacitors 340-341). The switch block 78 is also coupled to the processor 65 and includes a single pole double throw switch 74, for example, capacitors 312, 314, 316-317, and resistors 313, 315). Capacitors 320-321 are coupled between the processor 65 and the switch block 78. The first radiator feed path 89 illustratively includes a switch connector block 77 coupled between the ESD protection block 72 and the matching network block 71 (capacitor 332, resistor 333, and inductor 334). The switch connector block 77 is for use during production testing methods. As will be appreciated by those skilled in the art, FIGS. 10-11 illustrate example implementations of the schematic diagram of FIG. 9. These are presented for illustrative and exemplary purposes only. Indeed, not all components from FIG. 9 are included in the specific implementations of FIGS. 10-11, and some components have been altered slightly.

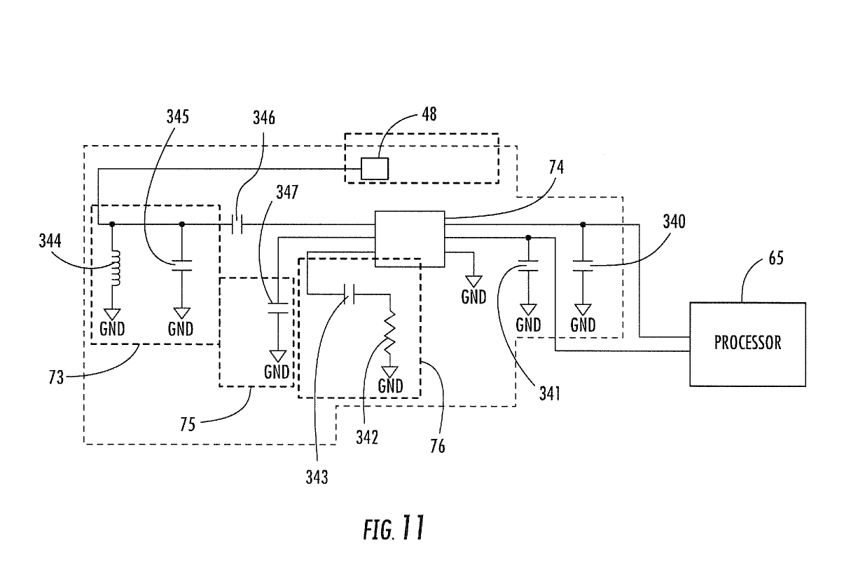

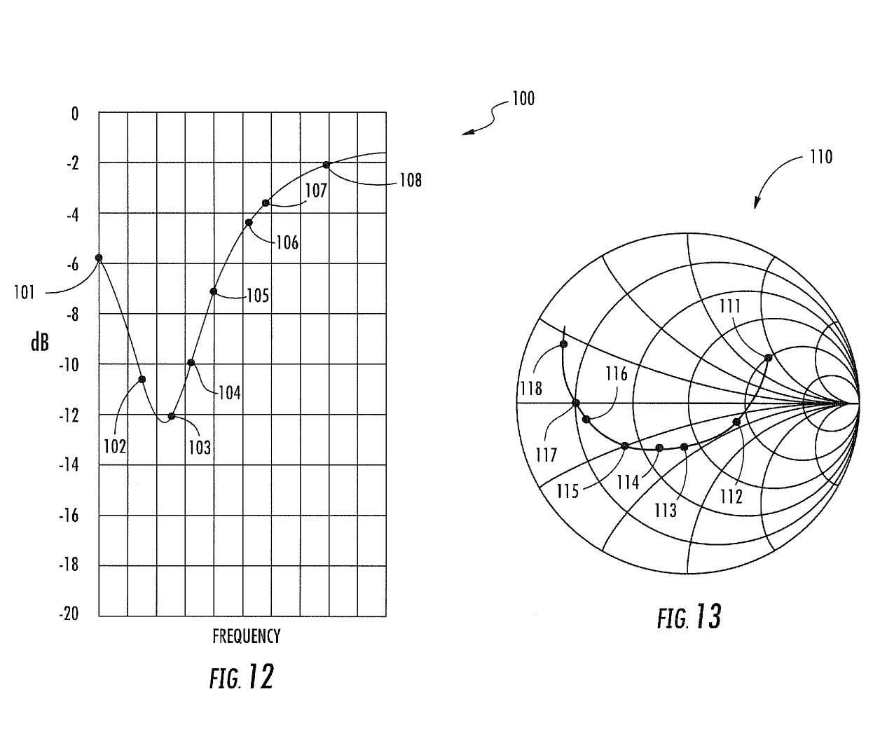

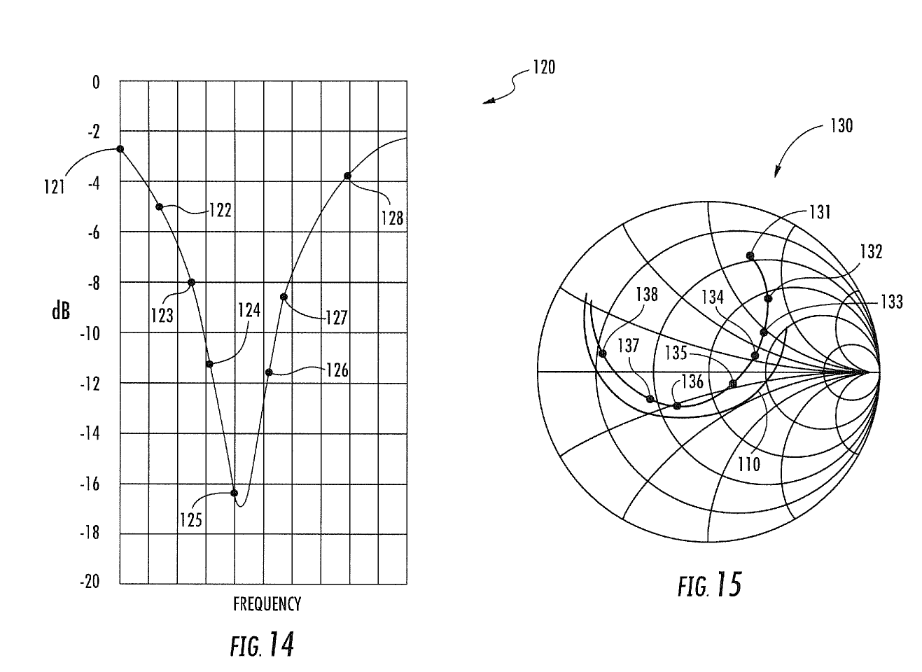

Referring now to FIGS. 12-16, several diagrams illustrate performance of an embodiment of the multiple-band antenna 32. In particular, diagrams 100, 110 show first radiator 33 performance in a first switched parasitic state while diagrams 120, 130 show first radiator performance in a second switched parasitic state. Data points 101-108 (FIG. 12), 111-118 (FIG. 13), 121-128 (FIGS. 14), and 131-138 (FIG. 15) specify performance at operating frequencies of 824.20 MHz, 849.00 MHz, 869.00 MHz, 894.00 MHz, 880.00 MHz, 915.00 MHz, 925.00 MHz, and 960.00 MHz, respectively. In FIG. 15, curve 110 illustrates performance of the parasitic switch state from FIG. 13. Diagram 250 shows first radiator 33 efficiency performance in first 252 and second 251 switched parasitic states.

In particular, diagrams 100 and 120 show the shift of the antenna resonance in the low band (frequency range 800-1000 MHz). The active antenna was designed to extend the bandwidth in the low band area.

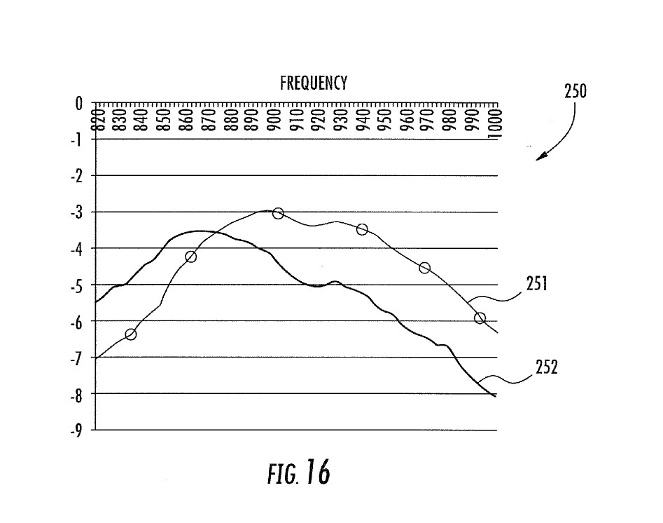

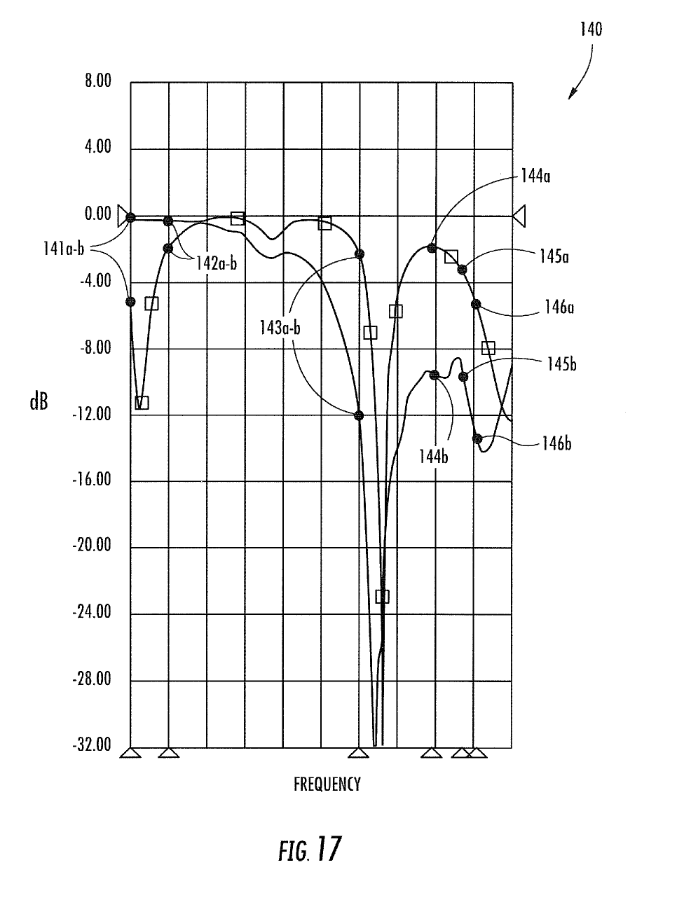

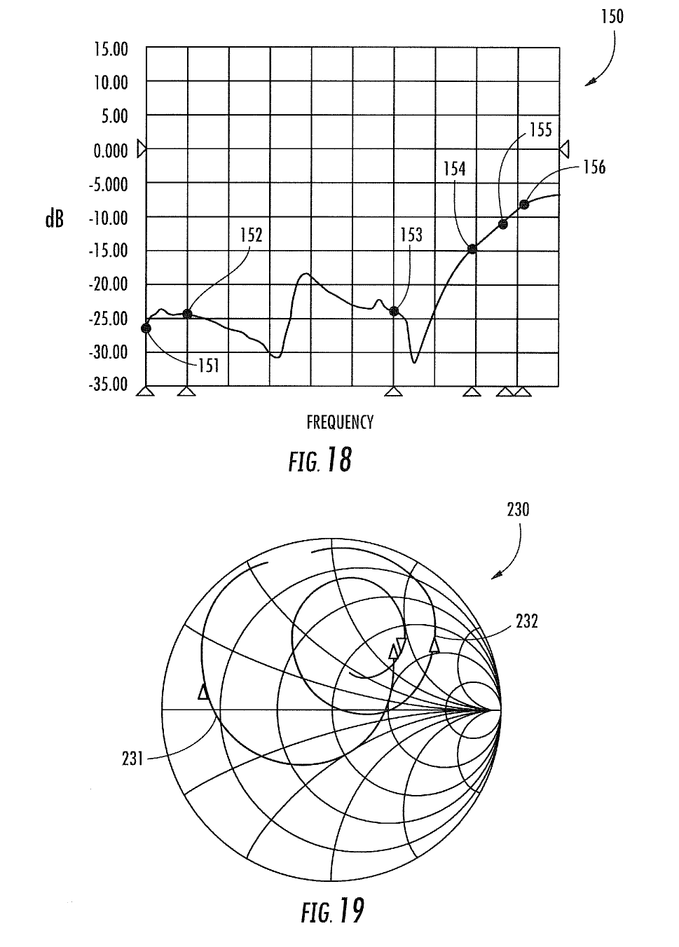

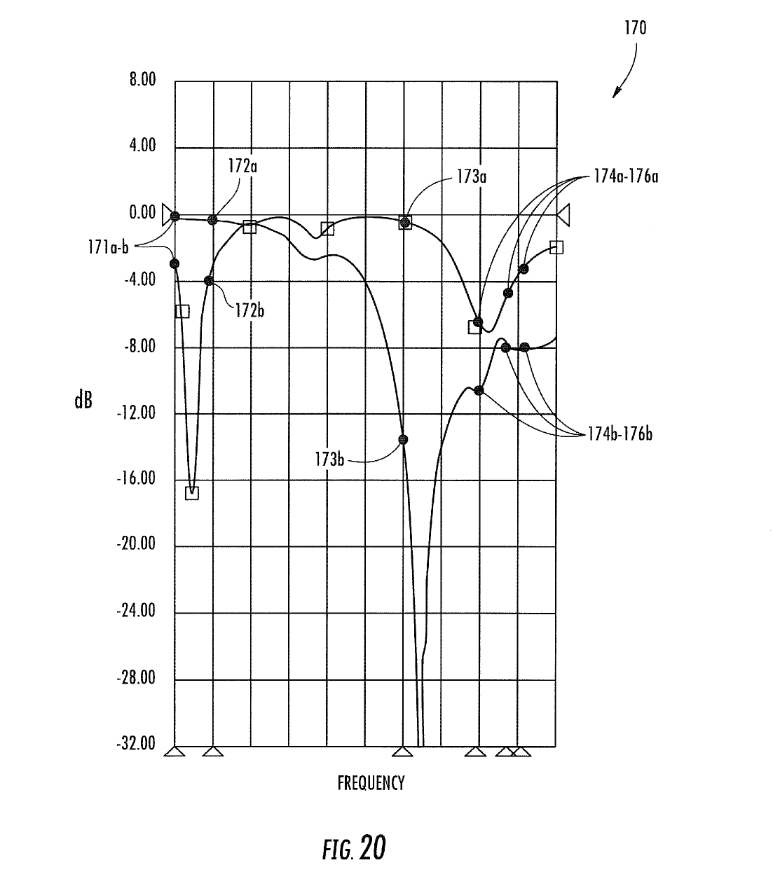

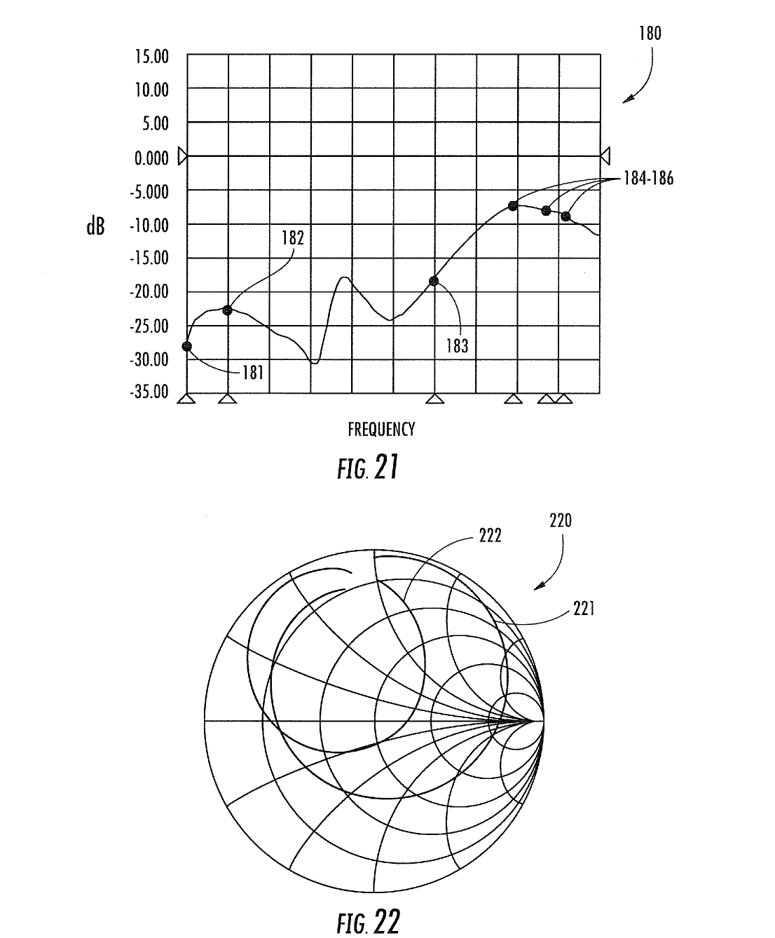

Referring now additionally to FIGS. 17-22 diagrams 140, 150, 230 illustrate coupling effects between the first and second radiators 33-34 in a first switched parasitic state while diagrams 170, 180, 220 show coupling effects between the first and second radiators in a second switched parasitic state. Data points 141a-146a, 141b-146b (FIG. 17), 151-156 (FIG. 18), 121-171a-176a, 171b-176b (FIGS. 20), and 181-186 (FIG. 21) specify performance at operating frequencies of 824.00 MHz, 960 MHz, 1.71 GHz, 1.99 GHz, 2.11 GHz, and 2.17 GHz, respectively. Diagram 230 includes curves 231-232, and diagram 220 includes curves 221-222.

The low band antenna (first radiator 33) also shows a 2nd resonance in the range of the high band antenna (second radiator 34). In the illustrated embodiments, the high band and low band antennas 33-34 are close together. The 2nd resonance of the low band antenna 33 will also interact with the 1st resonance of the high band antenna 34. In diagrams 140, 150, 230, the frequency range is extended, and the higher frequencies are shown. The diagrams include the range (800 MHz-2300 MHz), and aid in understanding the control enabled with the active antenna radiator switching state for the isolation between our low band and high band antennas 33-34. Diagram 140 shows return loss of both radiators for the switching state 1 (y-axis in dB, x-axis is frequency in MHz), and this figure shows the 1st and the 2nd resonances of the active antenna (low band radiator 33). The second resonance is overlapping with the resonance of the high band radiator 34 (antenna with T slot). This 2nd resonance causes a coupling between both radiators with impact to antenna isolation. Diagrams 150 and 230 show the coupling/isolation between both radiators, diagram 230 being another format (smith chart) of diagram 150. The antenna isolation impacts the efficiency, HAC and SAR.

Diagrams 170, 180, 220 show the same situation for the switched state 2. It is visible that not only the first resonance is affected, but also the 2nd resonance is shifted. The isolation between both antennas is changed (compare FIGS. 18 and 21). Again, diagram 220 provides another Smith diagram format.

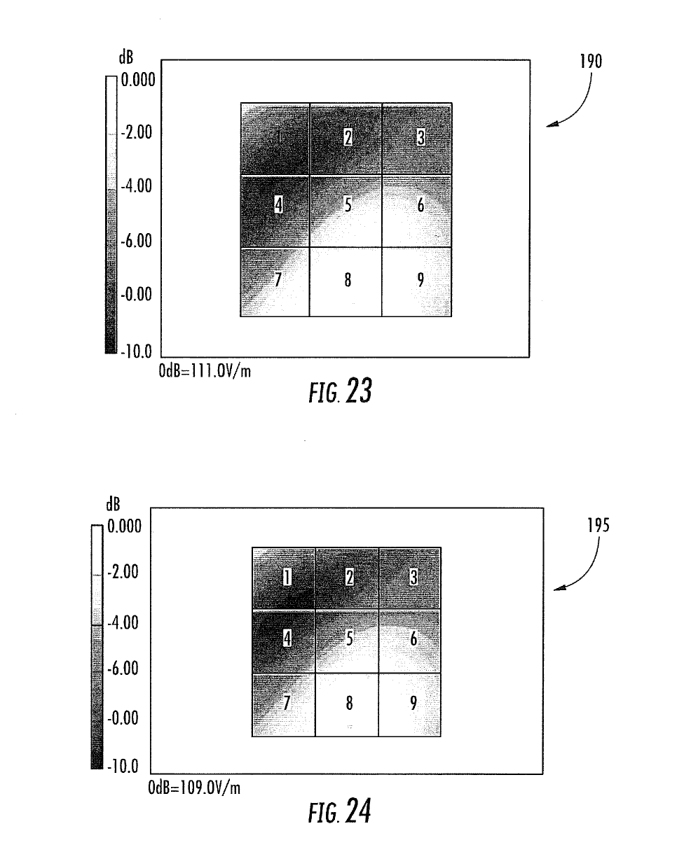

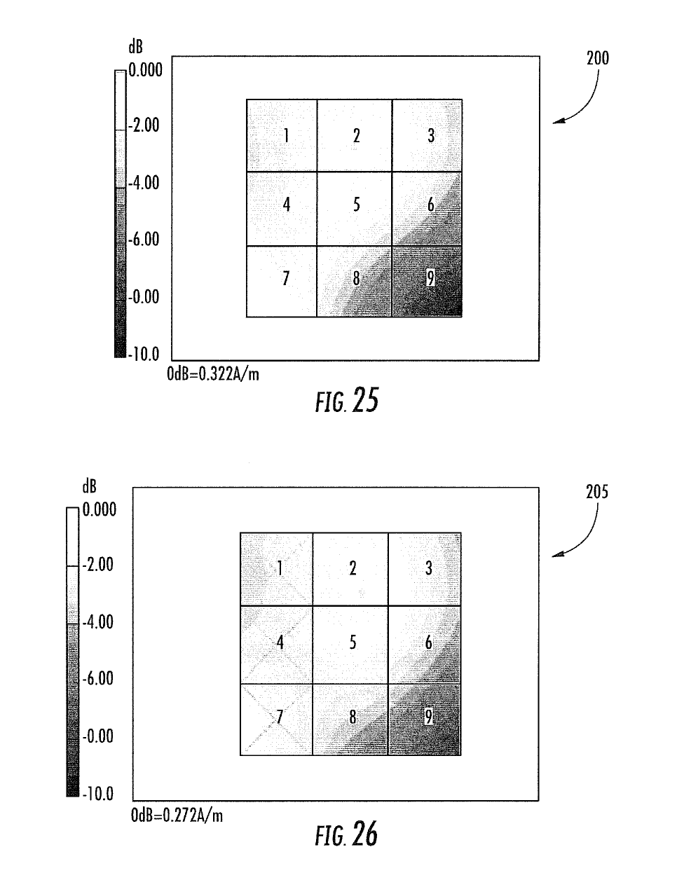

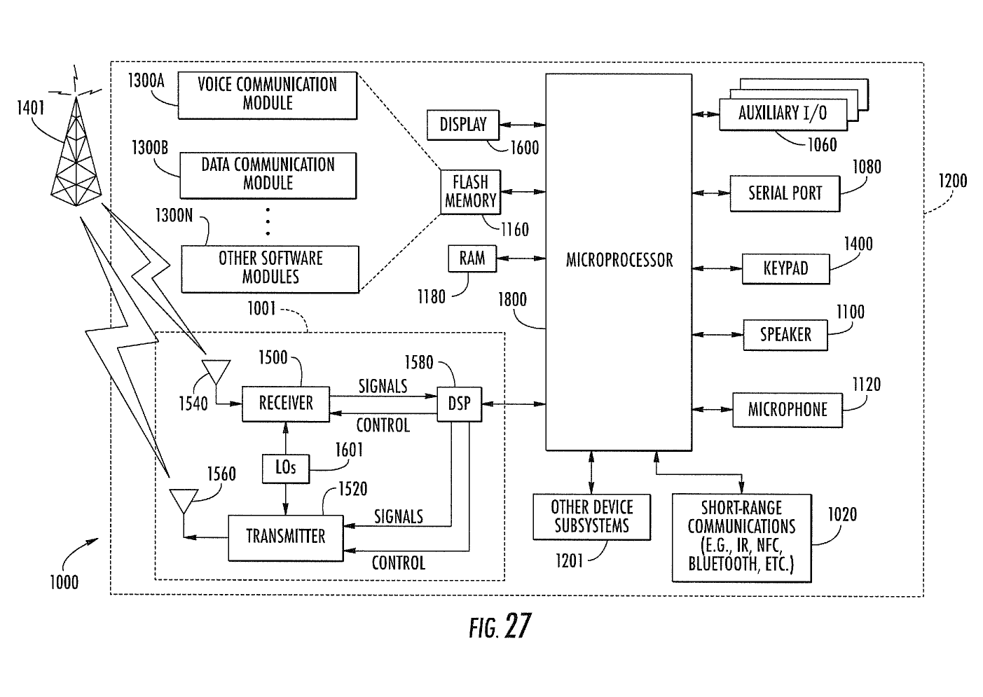

FIGS. 23-26 include diagrams 190, 195, which illustrate hearing aid compatibility (HAC) E-field results in first and second switched parasitic states. In typical cellular devices with multiple-band antennas, the reduced housing size and close proximity of the antenna and hearing aid components may cause self-interference issues. HAC requirements for the GSM 1900 band are stricter than that for the GSM 850 band. For below 0.96 GHz, the HAC category M3 limits (AWF=−5 dB) include a maximum electric field (E field) of 266.1 V/m and a maximum magnetic field (M field) of 0.80 A/m. For above 0.96 GHz, the HAC category M3 limits (AWF=−5 dB) include a maximum electric field (E field) of 84.1 V/m and a maximum magnetic field (M field) of 0.25 A/m. In particular, peak E-field measurements in V/m for the first switched parasitic state include: grid 1 75.4; grid 2 63.5; grid 3 65.4; grid 4 76.4; grid 5 98.6; grid 6 98.3; grid 7 101.5; grid 8 111.0; and grid 9 107.3. Peak E-field measurements in V/m for the second switched parasitic state include: grid 1 74.6; grid 2 59.9; grid 3 62.0; grid 4 76.0; grid 5 95.3; grid 6 94.7; grid 7 101.3; grid 8 109.1; and grid 9 103.8.

Diagrams 200, 205 illustrate hearing aid compatibility H-field in first and second switched parasitic states. In particular, peak H-field measurements in A/m for the first switched parasitic state include: grid 1 0.271; grid 2 0.281; grid 3 0.270; grid 4 0.272; grid 5 0.278; grid 6 0.265; grid 7 0.322; grid 8 0.253; and grid 9 0.205. Peak H-field measurements in V/m for the second switched parasitic state include: grid 1 0.223; grid 2 0.236; grid 3 0.231; grid 4 0.230; grid 5 0.235; grid 6 0.230; grid 7 0.272; grid 8 0.211; and grid 9 0.192. Advantageously, the first and second resonances of the first radiator 33 are managed, thereby mitigating a near field effect for the hearing aid earpiece. Indeed, as shown in diagrams 190, 195, 200, 205, the HAC values are clearly reduced in the second switched parasitic state.

Advantageously, in the mobile wireless communications device 30, the isolation (2nd resonance low band radiator 33 and 1st resonance high band radiator 34) between both antennas is controlled with the different switching states of our active low band antenna. In one case, high isolation is necessary to have the best antenna efficiency (GSM 1800, GSM 1900 RX, W-CDMA Band 1,2,4). This permits the multiple-band antenna 32 to realize this disclosed mechanical arrangement of the antennas being close together in a small volume. But in other cases (GSM 1900 TX (transmit)), the other switching state that gets less isolation can be used, which changes the field distribution on the PCB (printed wire board) and reduces HAC values. Of course, the antenna efficiency is compromised in this case. Nevertheless, mobile wireless communications device 30 does not need an extra HAC reduction structure, as required in typical cellular devices (traditional HAC reduction structures are separate metalized structures(L-stub, for example) mounted close to antenna). The design of the disclosed low band radiator 33 is made so that the 2nd resonance of the low band radiator is in the frequency range where we want to reduce HAC (GSM 1900 TX).

Example components of a mobile wireless communications device 1000 that may be used in accordance with the above-described embodiments are further described below with reference to FIG. 27. The device 1000 illustratively includes a housing 1200, a keyboard or keypad 1400 and an output device 1600. The output device shown is a display 1600, which may comprise a full graphic liquid crystal display (LCD). Other types of output devices may alternatively be utilized. A processing device 1800 is contained within the housing 1200 and is coupled between the keypad 1400 and the display 1600. The processing device 1800 controls the operation of the display 1600, as well as the overall operation of the mobile device 1000, in response to actuation of keys on the keypad 1400.

The housing 1200 may be elongated vertically, or may take on other sizes and shapes (including clamshell housing structures). The keypad may include a mode selection key, or other hardware or software for switching between text entry and telephony entry.

In addition to the processing device 1800, other parts of the mobile device 1000 are shown schematically in FIG. 27. These include a communications subsystem 1001; a short-range communications subsystem 1020; the keypad 1400 and the display 1600, along with other input/output devices 1060, 1080, 1100 and 1120; as well as memory devices 1160, 1180 and various other device subsystems 1201. The mobile device 1000 may comprise a two-way RF communications device having data and, optionally, voice communications capabilities. In addition, the mobile device 1000 may have the capability to communicate with other computer systems via the Internet.

Operating system software executed by the processing device 1800 is stored in a persistent store, such as the flash memory 1160, but may be stored in other types of memory devices, such as a read only memory (ROM) or similar storage element. In addition, system software, specific device applications, or parts thereof, may be temporarily loaded into a volatile store, such as the random access memory (RAM) 1180. Communications signals received by the mobile device may also be stored in the RAM 1180.

The processing device 1800, in addition to its operating system functions, enables execution of software applications 1300A-1300N on the device 1000. A predetermined set of applications that control basic device operations, such as data and voice communications 1300A and 1300B, may be installed on the device 1000 during manufacture. In addition, a personal information manager (PIM) application may be installed during manufacture. The PIM may be capable of organizing and managing data items, such as e-mail, calendar events, voice mails, appointments, and task items. The PIM application may also be capable of sending and receiving data items via a wireless network 1401. The PIM data items may be seamlessly integrated, synchronized and updated via the wireless network 1401 with corresponding data items stored or associated with a host computer system.

Communication functions, including data and voice communications, are performed through the communications subsystem 1001, and possibly through the short-range communications subsystem 1020. The communications subsystem 1001 includes a receiver 1500, a transmitter 1520, and one or more antennas 1540 and 1560. In addition, the communications subsystem 1001 also includes a processing module, such as a digital signal processor (DSP) 1580, and local oscillators (LOs) 1601. The specific design and implementation of the communications subsystem 1001 is dependent upon the communications network in which the mobile device 1000 is intended to operate. For example, a mobile device 1000 may include a communications subsystem 1001 designed to operate with the Mobitex™, Data TAC™ or General Packet Radio Service (GPRS) mobile data communications networks, and also designed to operate with any of a variety of voice communications networks, such as Advanced Mobile Phone System (AMPS), time division multiple access (TDMA), code division multiple access (CDMA), Wideband code division multiple access (W-CDMA), personal communications service (PCS), GSM (Global System for Mobile Communications), enhanced data rates for GSM evolution (EDGE), etc. Other types of data and voice networks, both separate and integrated, may also be utilized with the mobile device 1000. The mobile device 1000 may also be compliant with other communications standards such as 3GSM, 3rd Generation Partnership Project (3GPP), Universal Mobile Telecommunications System (UMTS), 4G, etc.

Network access requirements vary depending upon the type of communication system. For example, in the Mobitex and DataTAC networks, mobile devices are registered on the network using a unique personal identification number or PIN associated with each device. In GPRS networks, however, network access is associated with a subscriber or user of a device. A GPRS device therefore typically involves use of a subscriber identity module, commonly referred to as a SIM card, in order to operate on a GPRS network.

When required network registration or activation procedures have been completed, the mobile device 1000 may send and receive communications signals over the communication network 1401. Signals received from the communications network 1401 by the antenna 1540 are routed to the receiver 1500, which provides for signal amplification, frequency down conversion, filtering, channel selection, etc., and may also provide analog to digital conversion. Analog-to-digital conversion of the received signal allows the DSP 1580 to perform more complex communications functions, such as demodulation and decoding. In a similar manner, signals to be transmitted to the network 1401 are processed (e.g. modulated and encoded) by the DSP 1580 and are then provided to the transmitter 1520 for digital to analog conversion, frequency up conversion, filtering, amplification and transmission to the communication network 1401 (or networks) via the antenna 1560.

In addition to processing communications signals, the DSP 1580 provides for control of the receiver 1500 and the transmitter 1520. For example, gains applied to communications signals in the receiver 1500 and transmitter 1520 may be adaptively controlled through automatic gain control algorithms implemented in the DSP 1580.

In a data communications mode, a received signal, such as a text message or web page download, is processed by the communications subsystem 1001 and is input to the processing device 1800. The received signal is then further processed by the processing device 1800 for an output to the display 1600, or alternatively to some other auxiliary I/O device 1060. A device may also be used to compose data items, such as e-mail messages, using the keypad 1400 and/or some other auxiliary I/O device 1060, such as a touchpad, a rocker switch, a thumb-wheel, or some other type of input device. The composed data items may then be transmitted over the communications network 1401 via the communications subsystem 1001.

In a voice communications mode, overall operation of the device is substantially similar to the data communications mode, except that received signals are output to a speaker 1100, and signals for transmission are generated by a microphone 1120. Alternative voice or audio I/O subsystems, such as a voice message recording subsystem, may also be implemented on the device 1000. In addition, the display 1600 may also be utilized in voice communications mode, for example to display the identity of a calling party, the duration of a voice call, or other voice call related information.

The short-range communications subsystem enables communication between the mobile device 1000 and other proximate systems or devices, which need not necessarily be similar devices. For example, the short-range communications subsystem may include an infrared device and associated circuits and components, a Bluetooth™ communications module to provide for communication with similarly-enabled systems and devices, or a NFC sensor for communicating with a NFC device or NFC tag via NFC communications.

Many modifications and other embodiments will come to the mind of one skilled in the art having the benefit of the teachings presented in the foregoing descriptions and the associated drawings. Therefore, it is understood that various modifications and embodiments are intended to be included within the scope of the appended claims.

That which is claimed is:

1. A mobile wireless communications device comprising:
a housing;
at least one wireless transceiver carried by said housing; and
a multiple-band antenna carried by said housing and coupled to said at least one wireless transceiver, said multiple-band antenna comprising
a first radiator comprising a radiator element and a parasitic element adjacent thereto, said parasitic element being selectively switchable between floating and grounded states, and
a second radiator insulated from said first radiator.

2. The mobile wireless communications device of claim 1 wherein said multiple-band antenna comprises a dielectric substrate supporting said first and second radiators.

3. The mobile wireless communications device of claim 2 wherein said dielectric substrate has a non-planar shape.

4. The mobile wireless communications device of claim 2 wherein said dielectric substrate is carried by a bottom of said housing; and wherein said first and second radiators are carried by respective opposing first and second sides of said dielectric substrate.

5. The mobile wireless communications device of claim 1 wherein said second radiator comprises first and second branches coupled together with a T-shaped slot therebetween.

6. The mobile wireless communications device of claim 5 wherein said second radiator comprises a feed connection on said first branch, and a reference voltage connection on said second branch.

7. The mobile wireless communications device of claim 5 wherein said T-shaped slot opens outwardly and between said first and second branches.

8. The mobile wireless communications device of claim 1 wherein said radiator element comprises a first branch extending alongside said parasitic element, and a second branch extending outwardly from said first branch.

9. The mobile wireless communications device of claim 8 wherein said second branch has a bend in a medial portion thereof.

10. The mobile wireless communications device of claim 8 wherein said radiator element comprises a feed connection on said first branch.

11. The mobile wireless communications device of claim 1 wherein said parasitic element has a rectangular shape.

12. A multiple-band antenna for a mobile wireless communications device comprising a housing, and at least one wireless transceiver carried by the housing, said multiple-band antenna comprising:
a first radiator comprising a radiator element and a parasitic element adjacent thereto, said parasitic element being selectively switchable between floating and grounded states; and
a second radiator insulated from said first radiator.

13. The multiple-band antenna of claim 12 further comprising a dielectric substrate supporting said first and second radiators.

14. The multiple-band antenna of claim 13 wherein said dielectric substrate has a non-planar shape.

15. The multiple-band antenna of claim 13 wherein said dielectric substrate is carried by a bottom of the housing;
and wherein said first and second radiators are carried by respective opposing first and second sides of said dielectric substrate.

16. The multiple-band antenna of claim 12 wherein said second radiator comprises first and second branches coupled together with a T-shaped slot therebetween.

17. The multiple-band antenna of claim 16 wherein said second radiator comprises a feed connection on said first branch, and a reference voltage connection on said second branch.

18. The multiple-band antenna of claim 16 wherein said T-shaped slot opens outwardly and between said first and second branches.

19. The multiple-band antenna of claim 12 wherein said radiator element comprises a first branch extending alongside said parasitic element, and a second branch extending outwardly from said first branch.

20. A method of making a mobile wireless communications device comprising:
forming a multiple-band antenna to comprise
a first radiator comprising a radiator element and a parasitic element adjacent thereto, the parasitic element being selectively switchable between floating and grounded states, and
a second radiator insulated from the first radiator;
coupling at least one wireless transceiver to be carried by a housing; and
coupling the multiple-band antenna to be carried by the housing and to the at least one wireless transceiver.

21. The method of claim 20 wherein forming the multiple-band antenna comprises forming a dielectric substrate to support the first and second radiators.

22. The method of claim 21 wherein forming the multiple-band antenna comprises forming the dielectric substrate to have a non-planar shape.

23. The method of claim 21 further comprising coupling the dielectric substrate to be carried by a bottom of the housing, and coupling the first and second radiators to be carried by respective opposing first and second sides of the dielectric substrate.

24. The method of claim 20 wherein forming the multiple-band antenna comprises forming the second radiator to comprise first and second branches coupled together with a T-shaped slot therebetween.

25. The method of claim 24 wherein forming the multiple-band antenna comprises forming the second radiator to comprise a feed connection on the first branch, and a reference voltage connection on the second branch.
